(19) United States
(12) Patent Application Publication
(10) Pub. No.: US 2025/0005434 A1
(43) Pub. Date: Jan. 2, 2025

(54) END-TO-END AUTOMATION OPTIMIZATION FLYWHEEL

(71) Applicant: Microsoft Technology Licensing, LLC, Redmond, WA (US)

(72) Inventors: Lijun Peng, Sunnyvale, CA (US); Yi Zhang, Sunnyvale, CA (US); Mindaou Gu, Sunnyvale, CA (US); Yingxia Shi, Sunnyvale, CA (US)

(21) Appl. No.: 18/217,212

(22) Filed: Jun. 30, 2023

(51) Int. Cl. G06N 20/00

(52) U.S. Cl. CPC G06N 20/00

(57) ABSTRACT

In an example embodiment, a solution is provided that enables end-to-end automation across many different components in an online network. End-to-end optimization is a machine learning approach where the entire system, from input to output, is optimized as a whole, without breaking it down into separate components. In other words, the optimization is performed over the entire pipeline of the system, rather than optimizing each component separately.

### TECHNICAL FIELD

The present disclosure generally relates to technical problems encountered in machine learning. More specifically, the present disclosure relates to the use of an end-to-end automation optimization flywheel.

### BACKGROUND

The rise of the Internet has occasioned two disparate yet related phenomena: the increase in the presence of online networks, such as social networking services, with their corresponding user profiles visible to large numbers of people, and the increase in the use of these online networking services to provide content. An example of such content is advertising content, but similar issues can arise with many different types of content. In the advertising content example, advertisements (also known as sponsored content) may be posted to a social networking service to be presented to users of the social network service, oftentimes in conjunction with non-advertisement content (also known as organic content). For example, advertisements may be interspersed in a social networking feed on the social networking service, with a feed being a series of various pieces of content presented in reverse chronological order, along with non-advertisement content such as a combination of notifications, articles, and job listings.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a flow diagram illustrating a method, in accordance with an example embodiment.

FIG. 4 is a screen capture of a first screen of the graphical user interface, in accordance with an example embodiment.

FIG. 5 is a screen capture of a second screen of the graphical user interface, in accordance with an example embodiment.

FIG. 6 is a screen capture of a third screen of the graphical user interface, in accordance with an example embodiment.

FIG. 7 is a screen capture of a fourth screen of the graphical user interface, in accordance with an example embodiment.

FIG. 8 is a screen capture of a fifth screen of the graphical user interface, in accordance with an example embodiment.

FIG. 9 is a block diagram illustrating a software architecture, in accordance with an example embodiment.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

Technical problems are encountered owing to the fact that many social networking services, and online portals in general, have multiple different components that handle various elements of a piece of content's lifecycle. An advertisement, for example, may be created in one component, while an audience for the content is determined using a different component, and a bid price for the piece of content may be automatically determined using yet another component. Each of these components may utilize machine learning models to perform various tasks, but due to the separateness of these components, the machine learning models operate independently of one another, leading to various inefficiencies.

In an example embodiment, a solution is provided that enables end-to-end automation across many different components in an online network. End-to-end optimization is a machine-learning approach where the entire system, from input to output, is optimized as a whole, without breaking down the system into separate components for the purpose of optimization. In other words, the optimization is performed over the entire pipeline of the system, rather than optimizing each component separately. In this particular case, the end-to-end optimization may be accomplished through a combination of embedding-based retrieval, privacy-preservation modelling, multi-task learning, reinforcement learning, and generative artificial intelligence (GAI).

This optimization process allows components to interact with each other in what may be called a “flywheel”, with each component relying on some aspect of at least one other component for joint optimization. This integrated approach allows for a seamless and efficient process to optimize various online network activities, such as content and/or advertising display, geared towards a unified goal. It additionally creates a closed optimization cycle where each component potentially interacts with each other, with the flywheel connecting and sharing knowledge among previously isolated optimization components to improve outcomes. For example, insights from measuring qualified leads and audience signals can be used to continuously improve model performance and drive further outcome optimization.

An online network may contain various different components, each programmed to perform a different task. Some of these components may utilize one or more machine learning models in the furtherance of those tasks. These machine learning models, however, are optimized independently of one another. In other words, each model is trained independently to one another to optimize a different goal. While there have been some efforts made to train co-existing machine learning models to optimize a single goal by, for example, training those machine learning models together, such efforts have been limited to machine learning models within the same component of an online network and thus have more traditionally overlapping goals.

In some online networks, however, the components perform significantly different tasks from one another, making training co-existing machine learning models from different components technically challenging. In other words, it is difficult to optimize models, located in completely distinct components and with different functionality, on one or more shared goals.

For example, in an online network hosting and presenting content, with promoted (i.e., paid) content presented as well, there may be a relevance component dedicated to improving content results by adjusting bidding and delivery strategies, based on aspects such as conversions and lead quality, an audience component dedicating to identifying the correct audience, based on aspects such as audience expansion, a creative component dedicated to ensuring that the right message is delivered to promote engagement with the online network, and a customer experience component dedicated to streamlining a campaign management process.

Furthermore, in an example embodiment, a user need only supply a small seed of information, such as the objective, and from there the end-to-end optimization flywheel is able to provide suggestions for the predicted target audience, the ad content, and the bidding and delivery mechanisms by leveraging information known about the user, their prior ad campaigns, and their known products (e.g., product pages).

These disparate components may all be created and managed using artificial intelligence-driven optimizations, specifically by using one or more machine learning models to make predictions about likelihoods of certain events happening and then optimizing actions based on the goals of the components. For example, the relevance optimization model may contain a machine learning model for conversion prediction that outputs a prediction of a likelihood that presenting a paid piece of content will result in some sort of downstream benefit to the entity that paid for the piece of content to be displayed (such as a sale based on a presented advertisement, or an application for a job associated with a presented job listing). That model, however, is basically trained to optimize for conversions, which may be a different goal than, for example, a machine learning model used by the audience component, which may be trained to optimize for user engagement.

In an example embodiment, a solution is provided that enables end-to-end automation across several different components in an online network. End-to-end optimization is a machine learning approach where the entire system, from input to output, is optimized as a whole, without breaking it down into separate components. In some example embodiments, the end-to-end optimization may be accomplished through a combination of embedding-based retrieval, privacy preservation modelling, multi-task learning, reinforcement learning, and generative artificial intelligence (GAI).

This acts to allow components to interact with each other in what may be called a “flywheel”, with each component relying on some aspect of at least one other component for joint optimization. This integrated approach allows for a seamless and efficient process to optimize various online network activities, such as content and/or advertising display, geared towards a unified goal. It additionally creates a closed optimization cycle where each component potentially interacts with each other, with the flywheel connecting and sharing knowledge among previously isolated optimization components to improve outcomes. For example, insights from measuring qualified leads and audience signals can be used to continuously improve model performance and drive further outcome optimization.

More particularly, in an example embodiment, a GAI model may be used to generate one or more embeddings for content, such as text content. These embeddings may then be fed into a separate audience prediction model that produces a predicted audience for the content. This predicted audience may then be passed to a separate relevance and optimization model that is trained to predict relevance of a piece of content to users in the predicted audience. The audience prediction model and the relevance and optimization model may be trained to optimize a unified goal, and may act to essentially continuously “retrain” each other to optimize that goal. Thus, while each individual model may be trained to optimize their own goal (e.g., the audience prediction model being trained to identify an audience most likely to engage with a piece of content and the relevance and optimization model trained to identify a piece of content to display to users in an audience), by optimizing both together on a unified goal (e.g., maximizing value to an online platform in which the piece of content is being considered for display), then the system as a whole is able to function more effectively than if each model were trained and retrained separately.

In an example embodiment, the audience prediction model is a two-tower neural network machine learning model. Two-tower embeddings utilize a single neural network that combines two neural networks working in parallel, one that maps query features to query embeddings and one that maps item features to an item embedding. The output of the combination neural network is a dot product of the outputs of the two individual neural networks.

More particularly, in a two-tower network, a first neural network contains an embedding layer and hidden layer, and a second neural network contains an embedding layer and a hidden layer. Given feature vectors, the two towers provide embedding functions which encode the features to a k-dimensional embedding space. This is performed by optimizing both towers towards a single goal.

The relevance and optimization model may be a deep learning conversion model that predicts relevance based upon multiple types of conversion metrics. In some example embodiments, the relevance and optimization model may also be trained via federated learning.

Regardless of these specific examples, each of the models may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

With respect to the GAI model, as mentioned earlier this model may be used to generate embeddings, but it could also be used to, in lieu of or in conjunction with the generation of embeddings, generate some or all of the content itself. GAI refers to a class of artificial intelligence techniques that involves training models to generate new, original data rather than simply making predictions based on existing data. These models learn the underlying patterns and structures in a given dataset and can generate new samples that are similar to the original data.

Some common examples of GAI models include Generative Adversarial Networks (GANs), Variational Autoencoders (VAEs), and autoregressive models. These models have been used in a variety of applications such as image and speech synthesis, music composition, and the creation of virtual environments and characters.

When a GAI model generates new, original data, it goes through the process of evaluating and classifying the data input to it. In an example embodiment, the product of this evaluation and classification is utilized to generate embeddings for data, rather than using the output of the GAI model directly. Thus, for example, passing a user profile from an online network to a GAI model might ordinarily result in the GAI model creating a new, original user profile that is similar to the user profile passed to it. In an example embodiment, however, the new, original user profile is either not generated, or simply discarded. Rather, an embedding for the user profile is generated based on the intermediate work product of the GAI model that it would produce when going through the motions of generating the new, original user profile.

More particularly, the GAI model is used to generate content understanding in the form of the embeddings, rather than (or in addition to) generating content itself.

In an example embodiment, the GAI model is implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or Bidirectional Encoder Representations from Transformers (BERT) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer-to-language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a GAN embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game, according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, as we discussed in the previous section, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code.

In either case, the GAI model contains a generative classifier, which can be implemented as, for example, a naïve Bayes classifier. It is the output of this generative classifier that can be leveraged to obtain embeddings, which can then be used as input to a separately trained machine learning model.

The above generally describes the overall process as used during inference-time (when the machine learning model makes the predictions about each piece of content being considered for display in the feed), but the same or similar process of content understanding/embedding can be performed during training as well. Specifically, for some features of the training data used to train the machine learning model, those features are passed into the GAI model to generate an embedding that provides content understanding for those corresponding features. Thus, for example, in the case of a machine learning model used to predict propensity to interact with feed items, the training data may include historical information about past feed items displayed to users, user profile data about those users, and interaction information indicating when those users interacted with the various feed items. From that, for example, the past feed items may be passed one at a time into the GAI model to generate a corresponding embedding, and then the embeddings from the feed items can be used along with the features from the user profile data and interaction information to train the machine learning model using a machine learning algorithm.

This GAI model solution is especially useful when the data that is being embedded is content data (in contrast to, for example, user data). The reason is that for data such as user data, there already are robust models to generate content understanding based on, for example, user intent. In other words, machine learning models exist to fairly accurately predict a user's “intent” when encountering a particular graphical user interface (e.g., use it to find a job, use it to find candidate to apply for a job, use it to check up on their connections, etc.). Machine learning models also exist to fairly accurately predict what users would be similar to a given user. What is lacking, however, are machine learning models to accurately predict what a particular piece of content represents. The use of the GAI model to generate content understanding solves this technical problem.

In some example embodiments, the GAI model is used to generate single-dimension embeddings as opposed to multidimensional embeddings. A single-dimension embedding is essentially a single value that represents the content understanding. One specific way that the single-dimension embedding can be represented is as a category. Thus, in these example embodiments, the GAI model generates a category for a particular input piece of content. The categories may either be obtained by the GAI model from a fixed set of categories, or the categories may be supplied to the GAI model when the GAI model is generating the embedding (e.g., at the same time the piece of content is fed into the GAI model to be categorized).

In some example embodiments, the GAI model itself generates its own categories. In this case, the query to the GAI model may be something broad, such as “what is this piece of content about,” which allows the GAI model to generate a free-form description of the piece of content without being restricted to particular categories.

The other advantage to using a GAI model for content understanding of content to be fed to another machine learning model is that the GAI model is robust enough to handle content from different domains. The various pieces of content may be in completely separate types of domains (e.g., one may be textual, another may be a video). Additionally, even when the pieces of content are in similar domains (e.g., they are both textual), their formatting could be completely different (e.g., a news article is generally longer and uses a different writing style than a user posting an update about a job promotion they have received). The GAI model is able to handle content of different domains and actually share some of its understanding across those domains (e.g., feedback it has received about a user post about a recent court decision can influence its understanding about a new article about the court decision, or other court decisions).

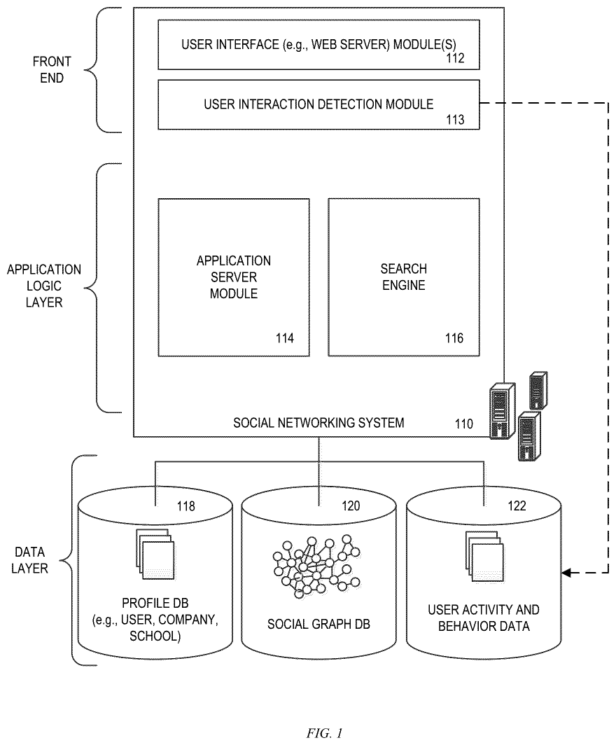

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behaviors may be logged or stored, for example, as indicated in FIG. 1, by the user activity and behavior database 122. This logged activity information may then be used by a search engine 116 to determine search results for a search query.

Although not shown, in some embodiments, a social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

At a threshold level, the present solution provides for the connecting of isolated optimization components and the continued automation of each component through artificial intelligence technologies.

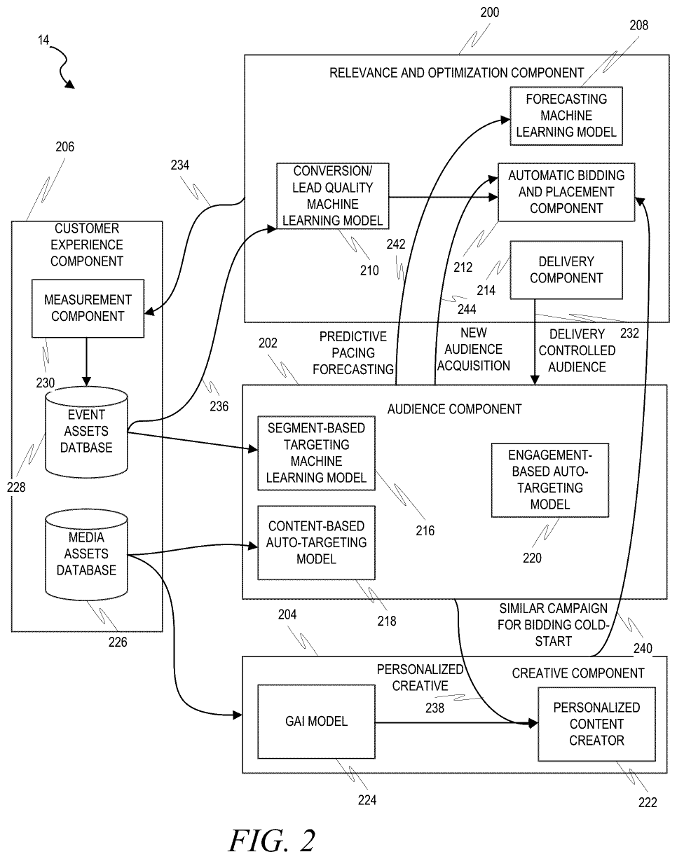

FIG. 2 is a block diagram illustrating the application server module 114 of FIG. 1 in more detail, in accordance with an example embodiment. While in many embodiments the application server module 114 will contain many subcomponents used to perform various different actions within the social networking system 110, in FIG. 1, only those components that are relevant to the present disclosure are depicted. Additionally, while a single application server module 114 is depicted here as containing many different components, in some example embodiments some or all of the different components may be located on different application server modules, and even some of the components may be located on client devices such as user devices.

Furthermore, in an example embodiment one or more of the models depicted in this figure may include explainable artificial intelligence (AI). Explainable AI is a set of processes and methods that allows users to understand and trust results and output created by machine learning models. Explainable AI is used to describe an AI model, its expected impact, and potential biases. It helps characterize model accuracy, fairness, transparency, and outcomes in AI decisions.

Here, application server module 114 may contain a relevance and optimization component 200, an audience component 202, a creative component 204, and a customer experience component 206. It should be noted that even though this figure depicts these components as residing on a single application server module 114, in implementation, it is possible that one or more of these components may reside on different application server modules 114, potentially located at different geographical locations.

The relevance and optimization component 200 improves advertising campaign results by adjusting bidding and delivery strategies. The building blocks for such goals may include, for example, conversion optimization, lead quality modeling, automatic bidding, automatic placement, dynamic margin (e.g., revenue minus costs), automatic format, dynamic group format, lifetime pacing, pacing forecast (e.g., forecast about when advertising budgets will be used up), and ads relevance. Thus, as depicted here, the relevance and optimization component 200 may include a forecasting machine learning model 208, a conversion/lead quality machine learning model 210, an automatic bidding and placement component 212, and a delivery component 214. The forecasting machine learning model 208 acts to predict future ad spending in a campaign. For example, it may utilize general predictive pacing forecasting information passed to it from the audience component 202, about the predicted pace of spending of advertisements traditionally displayed to the predicted audience and may generate a more specific pace of spending forecast for this particular advertising campaign.

The audience component 202 identifies a right audience for content (at scale). The building blocks for this goal may include, for example, audience expansion and predictive audience (predicting an audience for content). Thus, as depicted here, the audience component 202 may include a segment-based targeting machine learning model 216, a content-based auto-targeting model 218, and an engagement-based auto-targeting model 220. The engagement-based auto-targeting model provides a prediction of which audience members to target (e.g., which users to include in the audience) based on a likelihood of each of these audience members engaging with the content.

The creative component 204 ensures that the right message is delivered to promote engagement. The building blocks for this goal may include, for example, a personalized content creator 222 and a GAI model 224.

The customer experience component 206 streamlines the campaign management process. The building blocks for this goal may include, for example, a campaign manager, a business event manager, and an event/quality signal tracking. The customer experience component 206 may contain a media assets database 226, which supplies raw content and content-related information (such as text, video, and/or images used by the GAI model 224 to create new content in text, video, and/or video format). The GAI model 224 is capable of creating new content from scratch or capable of generating variants of existing content. In some examples, the GAI model 224 may also use existing content on the customer's product page. For example, contents from the customer's product page may be stored at the media assets database 226 or may be fed to the GAI model 224 directly from the customer's product page. The customer experience component 206 may further contain an event assets database 228 that contains information relating to events that occur related to user interaction with content. More particularly, measurements, such as a measurement taken by the relevance and optimization component 200, obtained by a measurement component 230, and stored in the event assets database 228 to be later used by the conversion/lead quality machine learning model 210.

In order to facilitate end-to-end optimization of all of these components in FIG. 2, connections between the components may be established in a manner that allows for such cross-component optimization. Specifically, connections between certain components can themselves be trained to optimize over some goal. For example, connection 232 in FIG. 2 is between relevance and optimization component 200 and audience component 202. A goal here may be to ensure that bidding on content does not get too high for a narrow audience, which would impair conversions. Thus, if the system as a whole determines that such a goal is not being met or might not be met if certain criteria related to bidding are strictly enforced, those criteria may be relaxed to find the nearest relevant audience to expand the audience for that particular content delivery to a wide enough level to ensure that the goal is met. This is why this connection 232 is labeled “delivery controlled audience”, because the audience itself (which is determined in the audience component 202) can be adjusted based on the delivery parameters (which are determined in the relevance and optimization component 200). Training of a model for this connection 232 uses tracking data to track the delivery parameters and the audience segments being served by the delivery.

Other connections, such as connection 234 between relevance and optimization component 200 and customer experience component 206 may not require training a model. Here, for example, the relevance and optimization component 200 may obtain feedback from delivery providers, such as advertisers, regarding performance (such as conversion rates). This information can then be passed via connection 234 to the customer experience component 206. This information may then be aggregated by a measurement component 230 and stored in an event assets database 228. The aggregated data can then be used by the relevance and optimization component 200 via connection 236 as an input to the conversion/lead quality machine learning model 210

Another example of a connection with a model that is learned via training includes connection 238, labeled “personalized creative”. Here, based upon the targeting intent from the audience component 202, a different piece of content (e.g., ad copy) may be generated in the creative component 204, to appeal to the specific audience determined in the targeting intent.

Another example of a connection that is learned via training includes connection 240, labeled “similar campaign for bidding cold-start.” The information generated via this connection involves information about what advertising campaigns might be similar to the present advertising campaign, which may be used when the user or user's company has no prior advertising campaign information to draw from (a so-called “cold-start” scenario).

Another example of a connection that is learned via training includes connection 242, labeled “predictive pacing forecasting.” The information generated via this connection involves information about the pace at which advertising campaigns generally would be predicted to spend on advertising to users within a predicted audience.

Another example of a connection that is learned via training includes connection 244, labeled “new audience acquisition.” The information generated via this connection involves information about the a predicted audience for the content.

The result of these connections is that an end-to-end flywheel is achieved. For example, for conversion optimization, which identifies deeper conversion opportunities through enhanced bidding, end-to-end deep learning models can be implemented across multiple conversion models, such as straight conversion, lead generation, and talent lead models, which makes it possible to extend functionality to a multi-layered model structure to incorporate additional conversion signals. Furthermore, third party conversion signals can be further leveraged in conversion optimization, such as offline conversions, customer relationship management, qualified leads, converted leaders, etc., to improve existing conversion models and build lead quality models. This provides valuable supplemental conversion signals in a privacy landscape. To achieve this, a two-layer federated learning model with privacy protection may be implemented. Additionally, a multi-task learning model may be built that differentiates leads by quality.

For delivery of content via the delivery component 214, in content marketplace optimization, bidding automation automatically adjusts bid prices in real-time to improve the efficiency and effectiveness of a campaign, and budget automation allows for optimized budget allocation across different ad placements and campaigns. More particularly, reinforcement learning-based bidding algorithms can be used across multiple bidding products, such as automatic bidding, manual bidding, and cost cap bidding, and can also be extended to achieve automated delivery across other products. The bidding models can now also incorporate additional signals such as audience and forecasting, as well as extending delivery automation across campaign groups.

For audience, audience creation allows content providers to automatically reach the right audience at the right time with optimized campaign performance, connecting members with the most relevant opportunities.

Embedding-based audience creation (auto targeting) can be provided, and it can also be extended to create predictive audiences, which incorporates content provider signals to generate audiences for optimal outcomes. Furthermore, in some example embodiments, delivery controlled audience serving can be provided, which converts audiences into parameters for tuning campaign performance by connecting it with budget delivery. To solve the cold-start problem when manual audience selection is discarded, additional signals can be incorporated from media assets, advertiser profiles, landing page content, etc. to establish content-based audience automation with large language models and generative artificial intelligence.

For the cold-start scenario, an initial audience can be generated, and content-based GAI model 224 may be used. More specifically, given text content (creative content, landing page content, text prompts, etc.), the key facet attributes can be predicted and summarized to jump-start campaign serving. Furthermore, GAI may be leveraged to generate embeddings of the content, to serve as pre-trained embeddings in a two-tower model trained using member-creative engagement data.

For creatives, creative optimization ensures that the right message is delivered to promote engagement. A personalized content creator 222 may be defined that creates a single location for uploading, managing, and selecting media for ad creation.

Referring back to the auto bidding and placement component 212, in an example embodiment, initial prices for pieces of sponsored content, called base bids, are set based on predictions of subsequent interactions with the sponsored pieces of content and daily budgets for the sponsored pieces of content. For example, one or more machine learned models may be used to predict the number of clicks, applications, and/or other types of interactions with a sponsored piece of content over a day based on historical time-series data associated with the interactions. An initial price for the sponsored piece of content may then be calculated by dividing the sponsored piece of content's daily budget by the predicted number of interactions. In an example embodiment, this predicted number of interactions is based on a corrected version of the number of impressions from the previous day.

The poster of a sponsored piece of content may set daily budgets for the sponsored content, from which costs are deducted as the users view the pieces of content. If a sponsored piece of content's budget is fully consumed before the end of the day, the sponsored piece of content may continue to be delivered to members (e.g., in search results and/or recommendations) until the end of the day without further charging the poster. Moreover, sponsored pieces of content with depleted budgets may occupy space in rankings that are shown to the users, which may prevent the online network from surfacing other sponsored pieces of content to the members and/or utilizing the budgets for the other sponsored pieces of content.

At impression-time, dynamic adjustments to the base bids are determined to improve utilization of the budgets and/or the performance of the impression. For example, a dynamic adjustment for improving utilization of a sponsored piece of content's budget may be calculated based on the actual spending for the sponsored piece of content at the current time and an expected spending for the sponsored piece of content generated by a pacing curve for the piece of content at the current time. A pacing curve is a measure of the pace at which impressions of a piece of content are being made. Impression-time is the time at which the online network retrieves and displays sponsored pieces of content to a particular user, and more particularly the time at which the online network has determined to display a particular sponsored piece of content to a particular user, but needs to determine the exact price of the impression. In another example embodiment, in a case where the sponsored content is a sponsored job listing, a dynamic adjustment for improving the performance of a sponsored job listing may be calculated based on factors such as the application rate for the job, an application rate for a job segment of the job listing, an applicant quality associated with applicants for the sponsored job listing, and/or an application quality associated with applications to job listings in the job segment.

An impression is a single display of the job listing in a graphical user interface. There may be numerous ways these impressions may be presented and numerous channels on which these impressions may be presented. For example, the impressions may be presented in an email to a user, in a feed of the online network, or as results of a job search. Some of these impressions may be for job listings where the corresponding entity that posted the job listing has agreed to pay for the impression. Such impressions are called “sponsored impressions”. It should be noted that there is a distinction between the corresponding entity having agreed to pay for the impression and the corresponding entity actually paying for the impression. As mentioned previously, it is possible that the entity may have agreed to pay for an impression but, at the time the impression is made, the daily budget established by the entity has been used up, and thus it becomes possible for the sponsored impression to be displayed without an actual charge being applied to the entity's account.

More particularly, companies may establish a daily budget they want to spend and a cost per impression based on a predicted number of impressions that they believe will occur each day. The actual display of the job listings, however, are based on a variety of factors that may vary based on the individual sets of users potentially served the job listing on a particular day. The result is that in some cases the predicted number of impressions may be reached before the day is up, leading the online network to be presented with a choice: stop displaying the job listing for the remainder of the day (which may result in no sponsored job listings being presented to a user later that day, which is not an optimal use of resources) or display the job listing without charging for it (essentially giving away impressions for free). From the technical perspective, the problem is that there is an area of the graphical user interface that is available to be used for a particular type of content (in this case, sponsored job listings) but that available area is not being utilized in an efficient manner in certain circumstances.

In an example embodiment, two different machine learned models are utilized to establish and refine the price set for each impression of a piece of sponsored content in the online network. It should be noted that organic content may be ranked separately using its own, independent ranking model, or the function(s) related to ranking the organic content may be integrated into the first machine learned model used for the sponsored pieces of content described below. The organic ranking functions are beyond the scope of the present disclosure, as the technical problems being addressed apply to sponsored content and not organic content. The first machine learned model is used to estimate the likelihood that display of a piece of sponsored content is “successful.” Success may be defined differently for different types of sponsored content, and will be described in more detail below. The score is then used to determine whether to display a particular sponsored piece of content to a particular user. If a piece of content is sponsored, display of the piece of content causes a charge to be assigned to the impression and the charge deducted from an entity's daily budget. The price charged for the sponsored piece of content is based on a bid that is calculated by first establishing a base bid for the sponsored piece of content. This base bid is based on an estimate of the number of views of the pieces of content. The second machine learned model is used to provide a correction of this estimated number of views of the sponsored pieces of content, thus making this dynamic bid more reliable. The base bid is then dynamically modified at impression-time to establish the actual price charged for a particular impression of the sponsored piece of content.

In line with the flywheel aspect described earlier, the second machine learned model of the models used to set a price for each impression may be a part of an end-to-end optimization process in which that second machine learned model is trained on a unified goal with the audience component 220, where output of each of the models are shared with each other and each model retrained to optimize that unified goal, above and beyond whatever goal(s) each model was/were originally trained on.

The following is an example of how the end-to-end automation optimization flywheel may be utilized. Monica, a marketer has a $200k budget to bring high-quality leads that are most likely to convert for her company's B2B Comm solutions. Monica is not sure what audience would be most interested in the Comm solutions. Ordinarily she would need to spend hours trying to navigate complex targeting options, and ultimately may wind up with an overly broad audience defined. Additionally, because of the importance of the product, she wants to maximize the formats and placements of advertisements in this campaign, and prepares many pieces of text and images to include in those advertisements. Then, when the campaigns are finally complete, if they do not work as well as she hoped, she will need to manually tune several of the parameters and/or modify the advertisements themselves.

If Monica, however, uses the end-to-end optimization flywheel, she is able to simply enter an automated campaign type and a total budget, specifying a goal of no more than a particular cost per lead. The audience is predicted for her campaign automatically, which targets users most likely to become qualified leads based on a customer lead list Monica has saved in a database. Ads are then automatically generated from assets Monica provides or even are automatically generated via the GAI model. She simply needs to approve or modify the advertisements, and the campaign can be launched. The end-to-end optimization flywheel is able to reoptimize the campaign automatically as it goes, and as such if it turns out, for example, that metrics begin to show that the predicted audience is too wide, it can automatically adjust to narrow the audience as well as automatically adjust the bids per impression to compensate for the poor metrics. The result is the system is self-correcting without the need for manual input from Monica, and the AI is able to hone in on an audience that actually converts.

Indeed, all Monica needs to do is provide an objective, and the end-to-end optimization flywheel can provide all of the rest of the information by utilizing information known about Monica, such as from a user profile, past campaigns from Monica or Monica's company, product information from product pages of Monica's company, etc.

Optionally, additionally powered by buyer understanding and customer provided data, this integrated approach creates a closed optimization loop where every component interacts with each other, resulting in a seamless and efficient process for optimizing advertising campaigns towards a unified goals.

Auto Audience Creation automates the audience targeting depending on the business goal marketers are trying to achieve and the results they are looking for. Auto Bidding not only sets bids according to the likelihood of business outcomes in each ad auction but also creates a feedback loop for dynamic audience adjustment, seeking to give advertisers the best possible value. Auto Delivery enables global return on investment optimization by looking at all available opportunities across placements and identities (group and member) via Auto Placement and Combined Marketplace.

Generative AI-powered auto ads creation simplifies the creation of high-performing ads and their assets, tailored to each audience or targeting criteria with minimal manual inputs required (e.g., budget, outcome goals).

Unlock performance towards new B2B outcome-based goals and full-funnel optimization. We will apply E2E Automation to achieve the complex task of performing towards new business outcome-based goals (qualified leads, sales, etc) and empower customers to build a prosperous full funnel B2B marketing strategy for long-term success.

A simplified campaign creation experience for automation is provided by reducing the setup steps, with minimal inputs required (e.g., budget, outcome goals) to get new and early customers to onboard fast and realize the value. By leveraging implicit and explicit data about the advertiser (e.g., advertiser profile) as well as signals about their landscape (social listening, competitor insights, past performance, etc.), the system can generate a suggested ad for the advertiser to help them optimize their goals.

The end-to-end optimization flywheel provides the capabilities for either manual or automatic input of information at various stages. More specifically, a user can provide manual input of one or more of audience, budget, ad content, objective, etc. but any one of these pieces of input can be automatically suggested to the user by the end-to-end optimization flywheel using the machine learning capabilities described above.

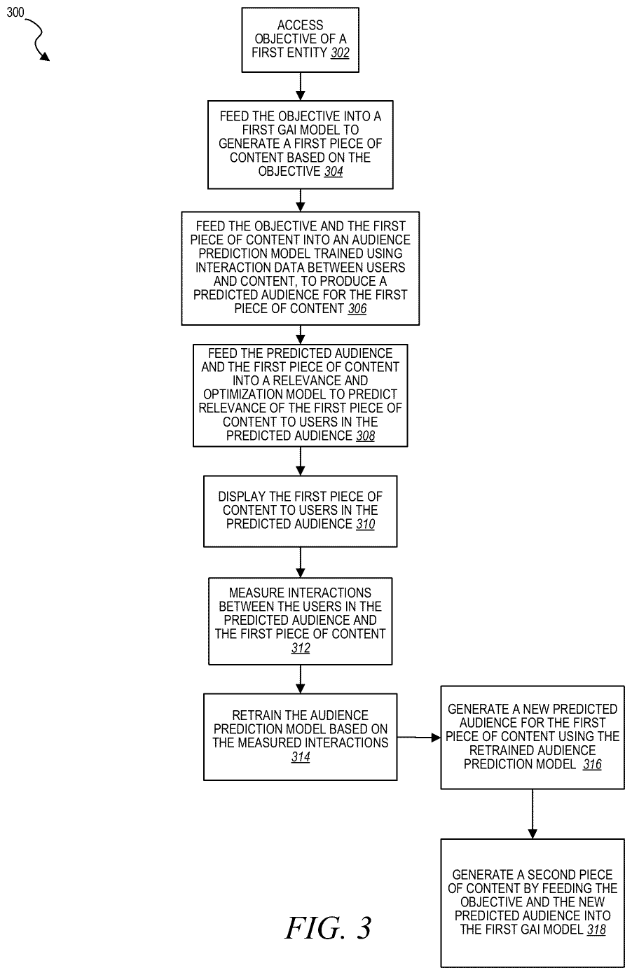

FIG. 3 is a flow diagram illustrating a method 300, in accordance with an example embodiment. At operation 302, an objective of a first entity is accessed. This objective may be in many forms. In some example embodiments, the objective is explicitly specified by the first entity, such as by a marketer or other user providing a text-based objective via a user interface. In other example embodiments, the objective is inferred by passing one or more pieces of content into a model that produces an inferred intent or other objective based on the one or more pieces of content. In some example embodiments this model may be a GAI model that produces embeddings for pieces of content passed to it. The pieces of content may be items such as a profile page of the first entity, a product page of the first entity, prior advertisements or other content created by or for the first entity, etc.

At operation 304, the objective is fed into a first GAI model to generate a first piece of content based on the objective. At operation 306, the objective and the first piece of content are fed into an audience prediction model trained using interaction data between users and content, to produce a predicted audience for the first piece of content.

At operation 308, the predicted audience and the first piece of content are fed into a relevance and optimization model to predict relevance of the first piece of content to users in the predicted audience. The audience prediction model and the relevance and optimization model are trained to optimize a unified machine learning model goal to provide end-to-end automation for causing presentation of the first piece of content for users in the predicted audience according to the objective. In an example embodiment, the audience prediction model is a two-tower neural network machine learning model containing a first neural network having an embedding layer and a hidden layer and a second neural network having an embedding layer and a hidden later, the first neural network trained on user data and the second neural network trained on content data.

At operation 310, the first piece of content is displayed to users in the predicted audience. At operation 312, interactions between the users in the predicted audience and the first piece of content are measured. At operation 314, the audience prediction model is retrained based on the measured interactions. At operation 316, a new predicted audience is generated for the first piece of content using the retrained audience prediction model. Then at operation 318, a second piece of content is generated by feeding the objective and the new predicted audience into the first GAI model.

In some example embodiments, some or all of the above operations may be repeated continuously, essentially causing the various models to be trained and retrained based on outputs of the other models.

In some example embodiments, the first piece of content is a sponsored piece of content where an entity pays a price each time the first piece of content is displayed or interacted with, and the relevance and optimization model includes an automatic bidding component that dynamically adjusts base bids for the price, based on the predicted relevance.

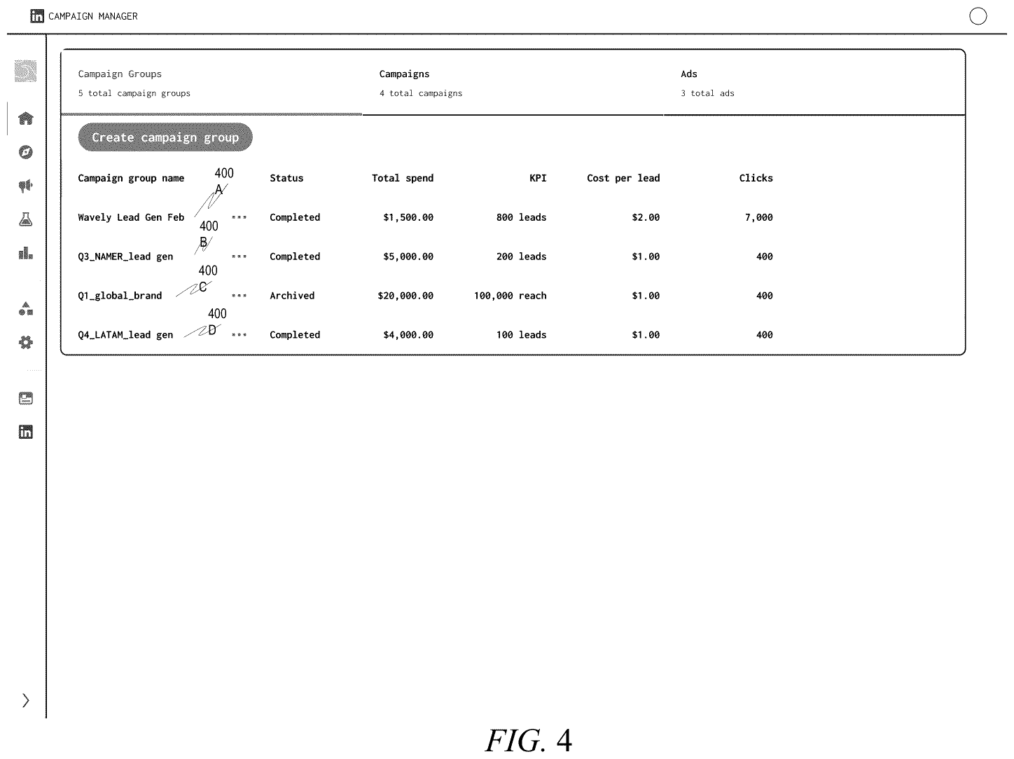

FIGS. 4-8 depict how a user is able to create an advertising campaign without needing to explicitly specific much information, instead relying on the end-to-end optimization flywheel to coordinate multiple components to create an advertising campaign based on very little explicit information.

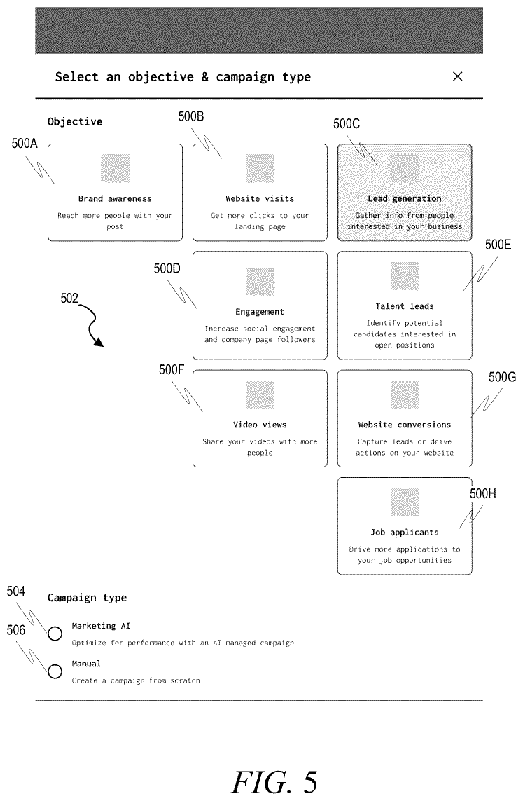

FIG. 4 is a screen capture of a first screen of the graphical user interface, in accordance with an example embodiment. Here the user is able to manage multiple campaign groups, such as campaign groups 400A, 400B, 400C, 400D. FIG. 5 is a screen capture of a second screen of the graphical user interface, in accordance with an example embodiment. Here, the user can specify an objective by selecting one of the objectives 500A-500H in an objective area 502 of the graphical user interface. Optionally, the user may select whether the campaign should be optimize for performance with an AI managed campaign using button 504 or create a campaign from scratch using button 506. Here the user may select lead generation 500C as an objective and to have the campaign AI optimized.

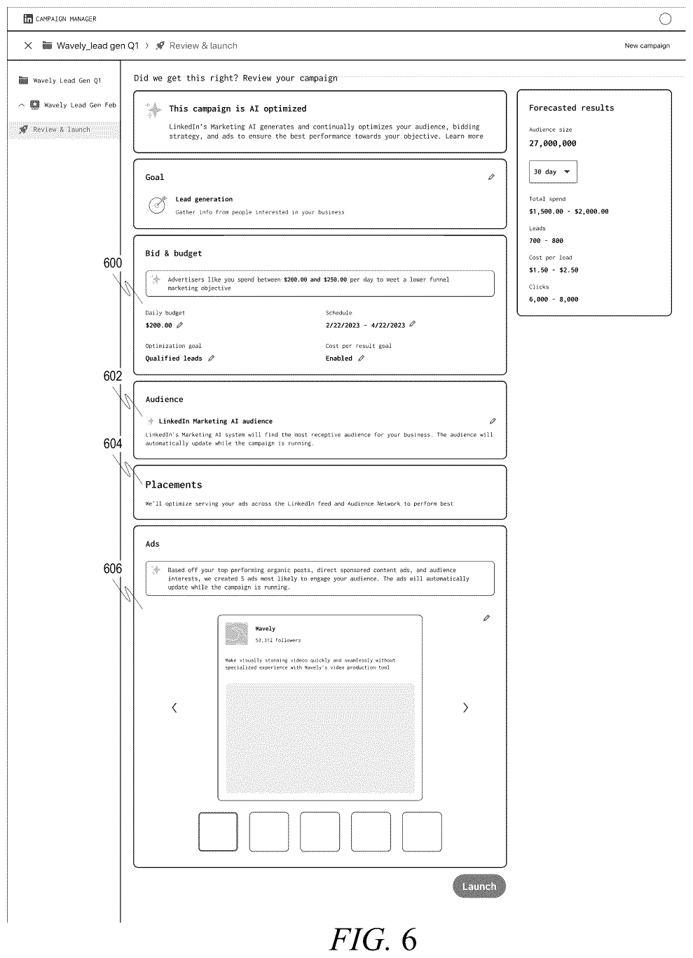

FIG. 6 is a screen capture of a third screen of the graphical user interface, in accordance with an example embodiment. Here, the output of the end-to-end optimization flywheel may be presented to the user, who can edit one or more aspects of the output. A recommended bid and budget 600 is provided, as is a recommended audience 602. A placements area 604 indicates that the system will optimize the ads across a feed and audience network, and generated advertisements may be presented in ads area 606. The user has the ability to override any of these settings and/or recommendations. Once the user is satisfied with the direction of the campaign, a launch button 608 may be selected.

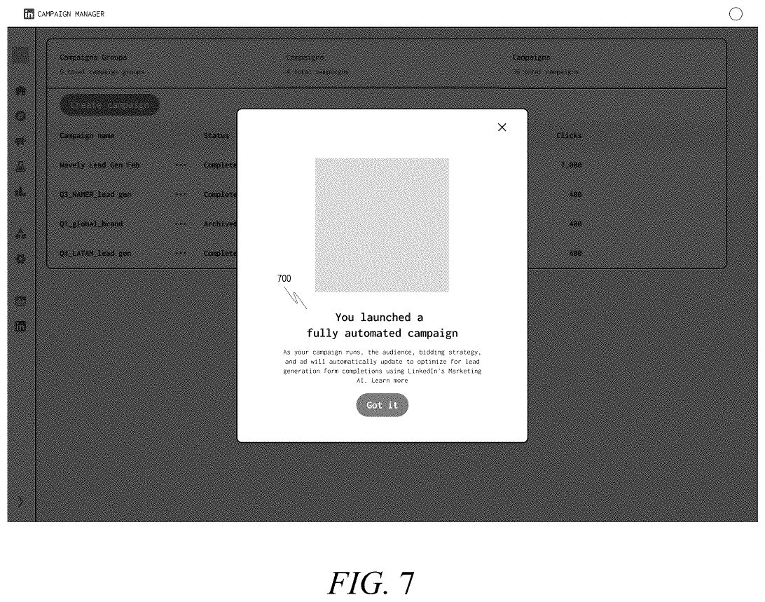

FIG. 7 is a screen capture of a fourth screen of the graphical user interface, in accordance with an example embodiment. This screen is displayed in response to the user selecting the launch button 608 from FIG. 6. A notification 700 is displayed informing the user of the launch of a fully automated campaign.

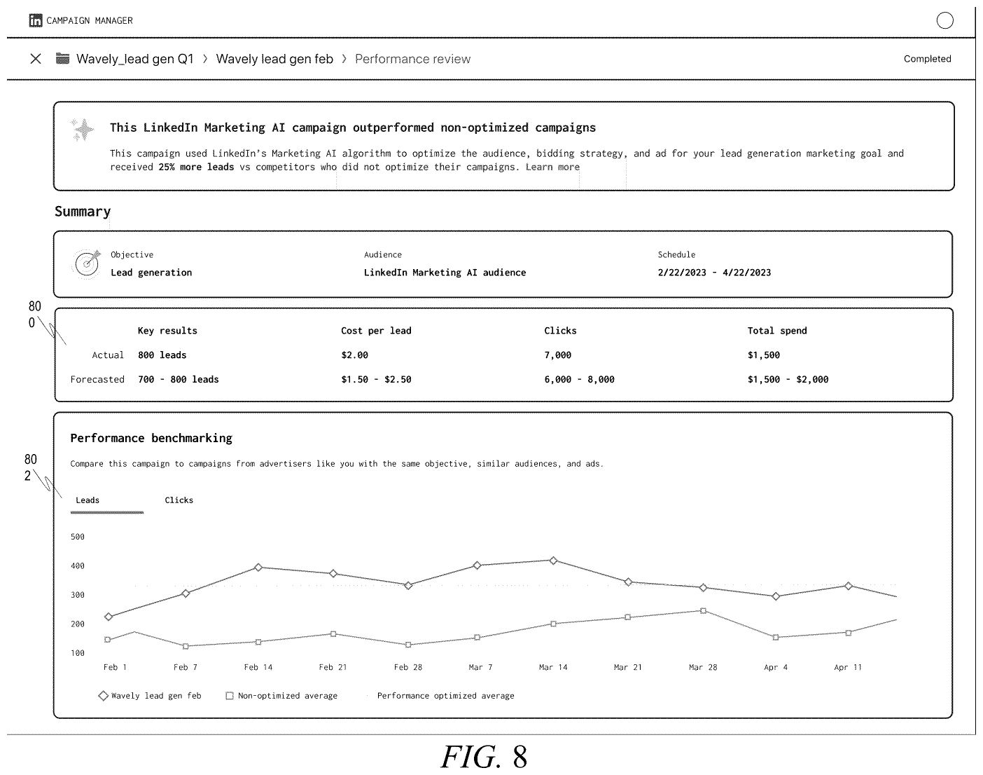

FIG. 8 is a screen capture of a fifth screen of the graphical user interface, in accordance with an example embodiment. This screen may be displayed once the campaign has launched and results have come in. Specifically, key results may be displayed in a key results area 800, and a performance benchmarking area 802 may display results benchmarked against prior statistical performances.

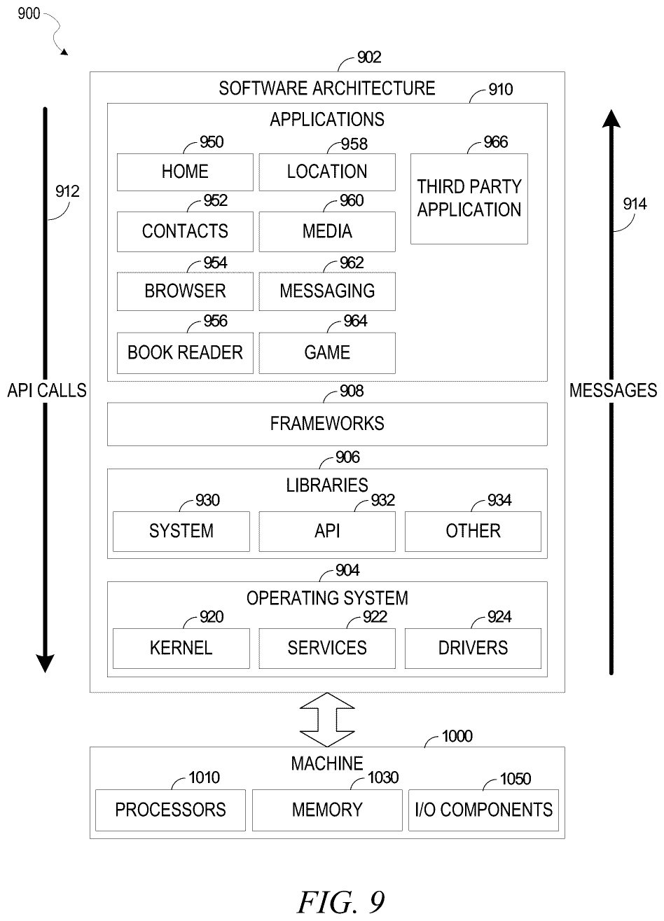

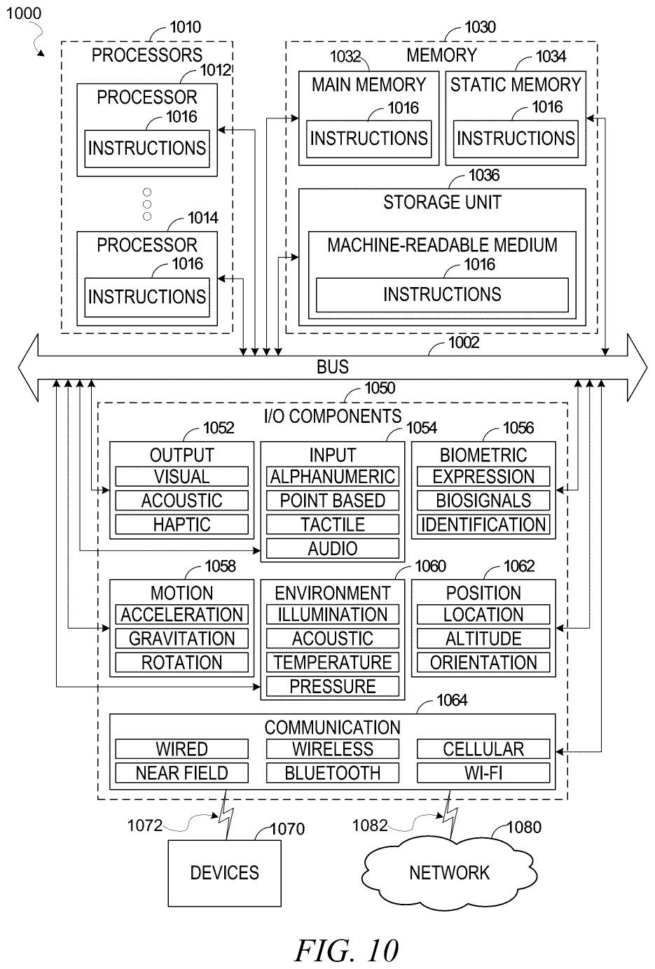

FIG. 9 is a block diagram 900 illustrating a software architecture 902, which can be installed on any one or more of the devices described above. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example architecture, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphical user interface functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application 910, an applet, an app, or other executable code) for causing the machine 1000 to perform any one or more of the methodologies discussed herein may be executed. For example, the instructions 1016 may cause the machine 1000 to execute the method 300 of FIG. 3. Additionally, or alternatively, the instructions 1016 may implement FIGS. 1-3, and so forth. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors 1012 (sometimes referred to as “cores”) that may execute instructions 1016 contemporaneously. Although FIG. 10 shows multiple processors 1010, the machine 1000 may include a single processor 1012 with a single core, a single processor 1012 with multiple cores (e.g., a multi-core processor), multiple processors 1010 with a single core, multiple processors 1010 with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine 1000 will depend on the type of machine 1000. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In various example embodiments, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1030, 1032, 1034, and/or memory of the processor(s) 1010) and/or the storage unit 1036 may store one or more sets of instructions 1016 and data structures (e.g., software) embodying or utilized by any one or more of the methodologies or functions described herein. These instructions (e.g., the instructions 1016), when executed by the processor(s) 1010, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1016 and/or data. The terms shall accordingly be taken to include, but not be limited to, solid-state memories, and optical and magnetic media, including memory internal or external to the processors 1010. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1080 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a non-transitory computer-readable medium having instructions stored thereon, which, when executed by a processor, cause the system to perform operations comprising:
accessing an objective of a first entity;
feeding the objective into a first GAI model to generate a first piece of content based on the objective;
feeding the objective and the first piece of content into an audience prediction model trained using interaction data between users and content, to produce a predicted audience for the first piece of content; and
feeding the predicted audience and the first piece of content into a relevance and optimization model to predict relevance of the first piece of content to users in the predicted audience, wherein the audience prediction model and the relevance and optimization model are trained to optimize a unified machine learning model goal to provide end-to-end automation for causing presentation of the first piece of content for users in the predicted audience according to the objective.

2. The system of claim 1, wherein the operations further comprise:
causing display of the first piece of content to users in the predicted audience;
measuring interactions between the users in the predicted audience and the first piece of content; and
retraining the audience prediction model based on the measured interactions.

3. The system of claim 2, wherein the operations further comprise:
producing a new predicted audience for the first piece of content using the retrained audience prediction model; and
generating a second piece of content by feeding the objective and the new predicted audience into the first GAI model.

4. The system of claim 1, wherein the objective is obtained by accessing a text-based objective explicitly provided by an entity.

5. The system of claim 1, wherein the objective is obtained by feeding one or more pieces of content into a second GAI model to generate one or more embeddings.

6. The system of claim 1, wherein the audience prediction model is a two-tower neural network machine learning model containing a first neural network having an embedding layer and a hidden layer and a second neural network having an embedding layer and a hidden later, the first neural network trained on user data and the second neural network trained on content data.

7. The system of claim 1, wherein the first piece of content is a sponsored piece of content where an entity pays a price each time the first piece of content is displayed or interacted with, and the relevance and optimization model includes an automatic bidding component that dynamically adjusts base bids for the price, based on the predicted relevance.

8. A method comprising:
accessing an objective of a first entity;
feeding the objective into a first GAI model to generate a first piece of content based on the objective;
feeding the objective and the first piece of content into an audience prediction model trained using interaction data between users and content, to produce a predicted audience for the first piece of content; and
feeding the predicted audience and the first piece of content into a relevance and optimization model to predict relevance of the first piece of content to users in the predicted audience, wherein the audience prediction model and the relevance and optimization model are trained to optimize a unified machine learning model goal to provide end-to-end automation for causing presentation of the first piece of content for users in the predicted audience according to the objective.

9. The method of claim 8, further comprising:
causing display of the first piece of content to users in the predicted audience;
measuring interactions between the users in the predicted audience and the first piece of content; and
retraining the audience prediction model based on the measured interactions.

10. The method of claim 9, further comprising:
producing a new predicted audience for the first piece of content using the retrained audience prediction model; and
generating a second piece of content by feeding the objective and the new predicted audience into the first GAI model.

11. The method of claim 8, wherein the objective is obtained by accessing a text-based objective explicitly provided by an entity.

12. The method of claim 8, wherein the objective is obtained by feeding one or more pieces of content into a second GAI model to generate one or more embeddings.

13. The method of claim 8, wherein the audience prediction model is a two-tower neural network machine learning model containing a first neural network having an embedding layer and a hidden layer and a second neural network having an embedding layer and a hidden layer, the first neural network trained on user data and the second neural network trained on content data.

14. The method of claim 8, wherein the first piece of content is a sponsored piece of content where an entity pays a price each time the first piece of content is displayed or interacted with, and the relevance and optimization model includes an automatic bidding component that dynamically adjusts base bids for the price, based on the predicted relevance.

15. A non-transitory machine-readable storage medium comprising instructions which, when implemented by one or more machines, cause the one or more machines to perform operations comprising:
accessing an objective of a first entity;
feeding the objective into a first GAI model to generate a first piece of content based on the objective;
feeding the objective and the first piece of content into an audience prediction model trained using interaction data between users and content, to produce a predicted audience for the first piece of content; and
feeding the predicted audience and the first piece of content into a relevance and optimization model to predict relevance of the first piece of content to users in the predicted audience, wherein the audience prediction model and the relevance and optimization model are trained to optimize a unified machine learning model goal to provide end-to-end automation for causing presentation of the first piece of content for users in the predicted audience according to the objective.

16. The non-transitory machine-readable storage medium of claim 15, wherein the operations further comprise:
causing display of the first piece of content to users in the predicted audience;
measuring interactions between the users in the predicted audience and the first piece of content; and
retraining the audience prediction model based on the measured interactions.

17. The non-transitory machine-readable storage medium of claim 16, wherein the operations further comprise:
producing a new predicted audience for the first piece of content using the retrained audience prediction model; and
generating a second piece of content by feeding the objective and the new predicted audience into the first GAI model.

18. The non-transitory machine-readable storage medium of claim 15, wherein the objective is obtained by accessing a text-based objective explicitly provided by an entity.

19. The non-transitory machine-readable storage medium of claim 15, wherein the objective is obtained by feeding one or more pieces of content into a second GAI model to generate one or more embeddings.

20. The non-transitory machine-readable storage medium of claim 15, wherein the audience prediction model is a two-tower neural network machine learning model.
